(19) United States
(12) Patent Application Publication
(10) Pub. No.: US 2017/0041185 A1
(43) Pub. Date: Feb. 9, 2017

(54) COMMUNICATION APPARATUS AND METHOD

(71) Applicant: FUJITSU LIMITED, Kawasaki-shi (JP)

(72) Inventor: Masahiro SAITOU, Kawasaki (JP)

(73) Assignee: FUJITSU LIMITED, Kawasaki-shi (JP)

(21) Appl. No.: 15/198,310

(22) Filed: Jun. 30, 2016

(30) Foreign Application Priority Data
Aug. 3, 2015 (JP) 2015-153525

(51) Int. Cl. H04L 12/24

(52) U.S. Cl. CPC H04L 41/0668; H04L 41/0681

(57) ABSTRACT

A communication apparatus configured to communicate with an external and to set a parameter for ensuring predetermined communication quality of received signal, includes a first communication circuit configured to set a first parameter in accordance with a first temperature thereof while the first communication circuit communicates with the external, and a second communication circuit configured to set a second parameter in accordance with a second temperature thereof while the first communication circuit communicates with the external, wherein when a difference between the first temperature and a temperature of the first communication circuit after setting the first parameter equals or exceeds a predetermined value, communicating with the external switches from the first communication circuit to the second communication circuit.

### CROSS-REFERENCE TO RELATED APPLICATION

This application is based upon and claims the benefit of priority of the prior Japanese Patent Application No. 2015-153525, filed on Aug. 3, 2015, the entire contents of which are incorporated herein by reference.

### FIELD

The embodiments discussed herein are related to communication apparatuses and methods.

### BACKGROUND

To date, there is known a communication apparatus including a communication circuit of the running system and a communication circuit of an extra system. There is also known a television transmitter that lists compensation values of a characteristic compensation device in a table and stores them in a plurality of groups in memory, and, when degradation characteristics vary as a result of switchover of a power amplifier or the like, reads preferable compensation values from the memory and collectively performs reconfiguration. There is also known an electronic apparatus in which a temperature sensor is arranged in accordance with a position at which each electronic circuit package is mounted.

As examples of related art, Japanese Laid-open Patent Publication No. 11-289496 and Japanese Laid-open Patent Publication No. 7-152442 are known.

When compensation values for ensuring communication quality as mentioned above vary in accordance with temperature, for example, when the environmental temperature greatly changes, errors occur in some cases both in the running system and in the extra system, making it impossible to perform switchover between the running system and the extra system.

### SUMMARY

According to an aspect of the invention, a communication apparatus configured to communicate with an external, the communication apparatus setting a parameter for ensuring predetermined communication quality of received signal, includes a first communication circuit configured to set a first parameter in accordance with a first temperature thereof while the first communication circuit communicates with the external, and a second communication circuit configured to set a second parameter in accordance with a second temperature thereof while the first communication circuit communicates with the external, wherein when a difference between the first temperature and a temperature of the first communication circuit after setting the first parameter equals or exceeds a predetermined value, communicating with the external switches from the first communication circuit to the second communication circuit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a communication apparatus according to a first embodiment;

FIG. 2 is a diagram illustrating an example of memory information of each card relative to temperature change in the first embodiment;

FIG. 3 is a diagram illustrating an example of parameters that a communication LSI according to the first embodiment uses for communication;

FIG. 4 is a flowchart illustrating an example of a process executed by a CPU of a card of a running system according to the first embodiment;

FIG. 5 is a flowchart illustrating an example of a process executed by a CPU of a card of an extra system according to the first embodiment;

FIG. 6 is a diagram depicting an example of operating timings of each card relative to temperature change in the first embodiment;

FIG. 7 is a diagram (1) illustrating an example of changes in memory information of each card relative to temperature change in the first embodiment;

FIG. 8 is a diagram (2) illustrating the example of changes in memory information of each card relative to temperature change in the first embodiment;

FIG. 9 is a diagram (3) illustrating the example of changes in memory information of each card relative to temperature change in the first embodiment;

FIG. 10 is a diagram (4) illustrating the example of changes in memory information of each card relative to temperature change in the first embodiment;

FIG. 11 is a flowchart illustrating another example of the process executed by the CPU of the card of the running system according to the first embodiment;

FIG. 12 is a flowchart illustrating another example of the process executed by the CPU of the card of the extra system according to the first embodiment;

FIG. 13 is a flowchart illustrating an example of a process executed by the CPU of the card of an extra system according to a second embodiment;

FIG. 14 is a diagram depicting an example of operating timings of each card relative to temperature change according to the second embodiment; and

FIG. 15 is a flowchart illustrating another example of the process executed by the CPU of the card of the running system according to the second embodiment.

### DESCRIPTION OF EMBODIMENTS

An object in one aspect of the present embodiments is to provide a communication apparatus and a switching method that enable switching between the running system and the extra system to be performed with reliability when temperature changes.

Hereinafter, embodiments of a communication apparatus and a switching method according to the present disclosure will be described in detail with reference to the drawings.

### First Embodiment

### Communication Apparatus According to First Embodiment

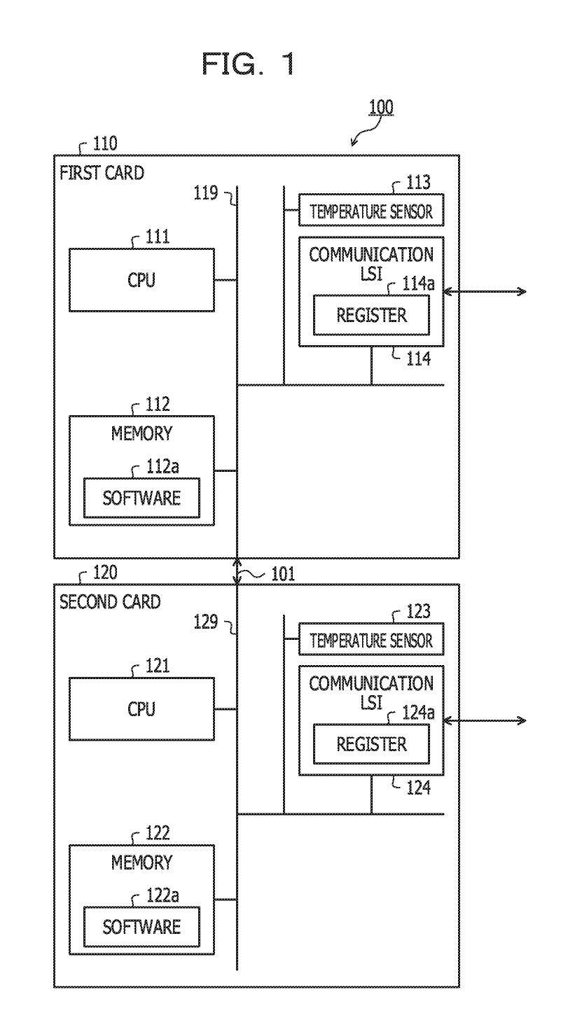

FIG. 1 is a diagram illustrating an example of a communication apparatus according to a first embodiment. As illustrated in FIG. 1, a communication apparatus 100 according to the first embodiment includes a first card 110 and a second card 120. One of the first card 110 and the second card 120 is set as the running system (current system) that performs transmission of main signals. The other of the first card 110 and the second card 120 is set to an extra system (standby system) that is arranged as an alternative to the running system in the redundant configuration.

For example, in the initial state, the first card 110 is set as the running system and the second card 120 is set as the extra system. Further, in the communication apparatus 100, switching between the running system and the extra system is performed. Once switching between the running system and the extra system is performed, the second card 120 serves as the running system and the first card 110 serves as the extra system.

The first card 110 and the second card 120 are capable of communicating with each other via a communication interface 101.

Communication interfaces of various types, such as a local area network (LAN) and direct current (DC) lines, may be used for the communication interface 101. For example, the first card 110 and the second card 120 synchronize with each other in terms of information via the communication interface 101.

Additionally, the first card 110 and the second card 120 are arranged close to (for example, adjacent to) each other in a shelf. For this reason, the respective environment temperatures of the first card 110 and the second card 120 are approximately the same.

The first card 110 includes, for example, a CPU 111, a memory 112, a temperature sensor 113, and a communication LSI 114. The CPU 111, the memory 112, the temperature sensor 113, and the communication LSI 114 are coupled to one another, for example, by an internal bus 119. A register 114a is a register included in the communication LSI 114.

The CPU 111 is a central processing unit (CPU) that is responsible for control over the entire first card 110. The memory 112 includes, for example, main memory and auxiliary memory. The main memory is, for example, random access memory (RAM). The main memory is used as a work area of the CPU 111. The auxiliary memory is nonvolatile memory such as, for example, a magnetic disk or flash memory. Various programs that cause the first card 110 to operate are stored in the auxiliary memory. The programs stored in the auxiliary memory are loaded into the main memory and are executed by the CPU 111.

For example, software 112a, which performs control and monitoring of the first card 110, is stored in the auxiliary memory of the memory 112. The software 112a is loaded into the main memory of the memory 112 and is executed by the CPU 111.

The temperature sensor 113 measures the temperature of the first card 110 (for example, the communication LSI 114). The CPU 111 is capable of reading, for example, a value representing a measurement result of temperature obtained by the temperature sensor 113 via the first card 110 from the temperature sensor 113.

The communication LSI 114 is a large scale integration (LSI) for communication that performs communication with a communication apparatus placed outside the communication apparatus 100, under control from the CPU 111. Communication performed by the communication LSI 114 may be communication using a LAN such as, for example, Ethernet (registered trademark). However, communication performed by the communication LSI 114 is not limited to this but may be optical communication or wireless communication such as, for example, synchronous optical network (SONET) or synchronous digital hierarchy (SDH).

When communication performed by the communication LSI 114 is communication through LAN such as Ethernet, the communication LSI 114 may be, for example, an L2 switch that performs switching of the layer 2. The communication LSI 114 may be implemented by a processor such as, for example, a field programmable gate array (FPGA) or a digital signal processor (DSP). The communication LSI 114 is also started via the internal bus 119 by the CPU 111. The starting of the communication LSI 114 includes booting, rebooting, first start-up, and resetting (restarting) of the communication LSI 114.

The communication LSI 114 also performs communication with a communication apparatus placed outside the communication apparatus 100 (a communication apparatus opposing to the communication apparatus 100) using communication parameters (set values). The communication parameter used by the communication LSI 114 is a parameter for ensuring predetermined communication quality for received signals. The communication parameter used by the communication LSI 114 is also a parameter having a value varying in accordance with (influenced by) the temperature of the communication LSI measured when the value of the parameter is set. The parameter having a value varying in accordance with temperature may be a parameter having a value set with reference to temperature, or may be a parameter having a value that is set without reference to temperature but is eventually influenced by temperature.

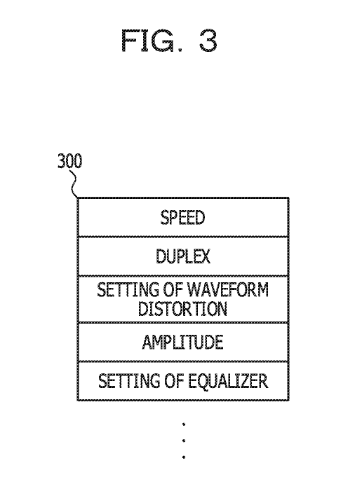

Setting communication parameters of the communication LSI 114 is performed, for example, upon start-up of the communication LSI 114. However, setting the communication parameters of the communication LSI 114 is not limited to being performed upon start-up of the communication LSI 114 but may be performed, for example, when given conditions are met after start-up of the communication LSI 114. Examples of the given conditions include input of an instruction from the outside and passage of a given time period. The communication parameter will be described below (for example, see FIG. 3).

Setting communication parameters of the communication LSI 114 is performed, for example, by an instruction from the CPU 111 via the internal bus 119. In this case, the values of communication parameters of the communication LSI 114 may be determined by the CPU 111 or may be determined by the communication LSI 114. The communication parameters of the communication LSI 114 are stored, for example, in the register 114a and thus are set for the communication LSI 114.

The second card 120 includes, for example, a CPU 121, a memory 122, a temperature sensor 123, and a communication LSI 124. The CPU 121, the memory 122, the temperature sensor 123, and the communication LSI 124 are coupled to one another by, for example, an internal bus 129. A register 124a is a register included in the communication LSI 124. The CPU 121, the memory 122, the temperature sensor 123, and the communication LSI 124 have configurations similar to those of the CPU 111, the memory 112, the temperature sensor 113, and the communication LSI 114, respectively.

Both the first card 110 and the second card 120 with the parameter values set in accordance with temperature described above perform communication with a communication apparatus opposing the communication apparatus 100.

With the configuration illustrated in FIG. 1, for example, when the first card 110 is the running system and the second card 120 is the extra system, a setting unit that performs setting of the values of parameters for the second card 120 may be implemented, for example, by the CPU 121 of the second card 120. A switching unit that switches a communication circuit that performs communication with the opposing (external) communication apparatus, from the first card 110 to the second card 120, may be implemented, for example, by the CPU 111 of the first card 110.

(Memory Information of Each Card Relative to Temperature Change in First Embodiment)

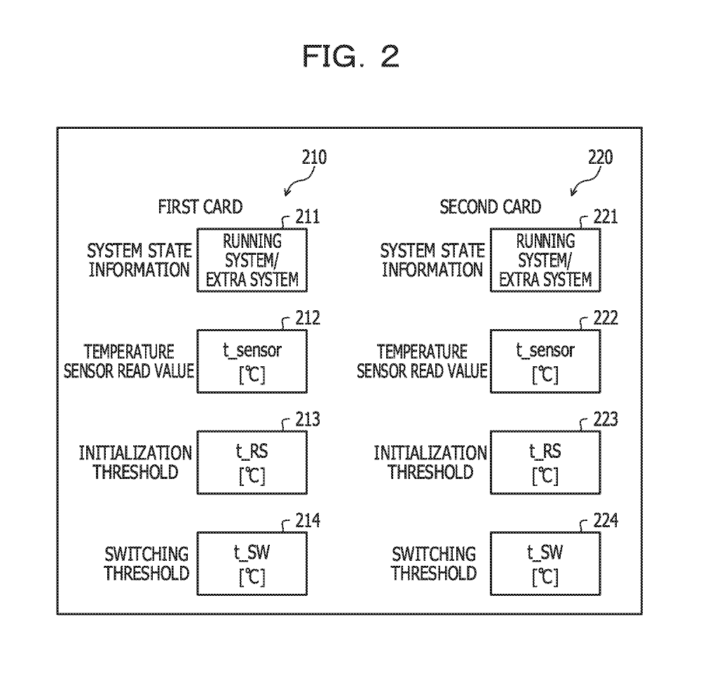

FIG. 2 is a diagram illustrating an example of memory information of each card relative to temperature change in the first embodiment. Memory information 210 illustrated in FIG. 2 is, for example, information stored in the memory 112 of the first card 110 and is information for use in the software 112a that is executed by the CPU 111. The memory information 210 includes system state information 211, a temperature sensor read value 212 (t_sensor), an initialization threshold 213 (t_RS), and a switching threshold 214 (t_SW).

The system state information 211 is information representing whether the first card 110 is currently the running system or the extra system. The temperature sensor read value 212 is a read value of the temperature sensor 113 upon start-up of the communication LSI 114, that is, information representing a temperature of the communication LSI 114 measured by the temperature sensor 113 upon start-up of the communication LSI 114.

The initialization threshold 213 is information representing a temperature width that is used as a condition for resetting and parameter setting of the communication LSI 114 when the first card 110 is the extra system. The switching threshold 214 is information representing a temperature width that is used as a condition for switching between the running system and the extra system when the first card 110 is the running system. The switching threshold 214 is set to a value larger than the initialization threshold 213 (t_SW>t_RS) so as to allow resetting of the extra system and setting (initialization) of parameters to be performed prior to switching between the running system and the extra system.

The system state information 211 and the temperature sensor read value 212 are stored, for example, in the main memory of the memory 112. The initialization threshold 213 and the switching threshold 214 are stored, for example, in the main memory or the auxiliary memory of the memory 112.

An information group 220 illustrated in FIG. 2 is, for example, information stored in the memory 122 of the second card 120 and is information for use in the software 122a that is executed by the CPU 121. The information group 220 includes system state information 221, a temperature sensor read value 222 (t_sensor), an initialization threshold 223 (t_RS), and a switching threshold 224 (t_SW).

The system state information 221 is information representing whether the second card 120 is currently the running system or the extra system. The temperature sensor read value 222 is a read value of the temperature sensor 123 upon start-up of the communication LSI 124, that is, information representing the temperature of the communication LSI 124 measured by the temperature sensor 123 upon start-up of the communication LSI 124.

The initialization threshold 223 is information representing a temperature width that is used as a condition for resetting of the communication LSI 124 and setting of parameters when the second card 120 is the extra system. The switching threshold 224 is information representing a temperature width that is used as a condition for switching between the running system and the extra system when the second card 120 is the running system. The switching threshold 224 is set to a value larger than the initialization threshold 223.

The system state information 221 and the temperature sensor read value 222 are stored, for example, in the main memory of the memory 122. The initialization threshold 223 and the switching threshold 224 are stored, for example, in the main memory or the auxiliary memory of the memory 122. Additionally, the initialization threshold 223 is set, for example, to a value equal to that of the initialization threshold 213 (t_RS). Additionally, the switching threshold 224 is set, for example, to a value equal to that of the switching threshold 214 (t_SW).

(Parameters that Communication LSI According to First Embodiment Uses for Communication)

FIG. 3 is a diagram illustrating an example of parameters that a communication LSI according to the first embodiment uses for communication. Parameters that the communication LSI 114 uses for communication will be described, and the description applies to parameters that the communication LSI 124 uses for communication. The communication LSI 114 uses, for example, parameters 300 illustrated in FIG. 3 for communication with a communication apparatus outside the communication apparatus 100. The parameters 300 are set by the communication LSI 114 in response to an instruction from the CPU 111, for example, at the time when the communication LSI 114 is started (at first start-up or at resetting)

The parameters 300 include the speed, the duplex, setting of waveform distortion, the amplitude, setting of an equalizer, and the like. The speed is a parameter for determining a communication speed (bps) in the communication LSI 114. The duplex is a parameter for determining whether to perform bidirectional communication or unidirectional communication. The setting of waveform distortion is a parameter for processing in which, when the communication LSI 114 receives a signal, a high-frequency component that is lost in a transmission path is emphasized (compensated for). The amplitude is a parameter for determining the amplitude of a signal when the communication LSI 114 transmits the signal.

The equalizer is a processing unit that changes the frequency characteristics of a signal when the communication LSI 114 receives the signal, so that the received signal has a waveform that is recovered from its degraded state occurring in the transmission path. For example, while applying fine adjustments to a set value within the equalizer, the equalizer operates so as to maintain a state where a signal is optimally received. As the equalizer, for example, a finite impulse response (FIR) filter or the like may be used. In this case, the equalizer is set, for example, to the initial value of a tap coefficient for the FIR filter.

For example, upon start-up of the communication LSI 114, the equalizer receives a known signal for testing from a communication apparatus serving as the communication destination (transmission source), and sets the initial value of a tap coefficient for the FIR filter in accordance with the received result. At this point, a suitable tap coefficient for the FIR filter differs in accordance with, for example, the temperature characteristics of the transmission path, the temperature characteristics of the communication LSI 114, or the like. Consequently, the initial value of the tap coefficient for the FIR filter is a parameter having a value varying in accordance with the temperature of the communication LSI 114 measured at the time when the initial value of the tap coefficient is set. That is, regarding the initial value of a tap coefficient for the FIR filter, although the value is set without reference to the temperature of the communication LSI 114, the set value is a parameter that is eventually influenced by the temperature.

Additionally, if the temperature of the communication LSI 114 greatly changes from the temperature measured at the time when the initial value of the tap coefficient is set, control over the tap coefficient for the FIR filter no longer follows a signal waveform degraded in the transmission path. Therefore, the set initial value of the tap coefficient is effective in a given temperature range relative to the temperature of the communication LSI 114 measured at the time when the initial value of the tap coefficient is set. When the temperature of the communication LSI 114 is outside the temperature range, the initial value of the tap coefficient for the communication LSI 114 has to be set again so that the signal waveform is recovered from its degraded state occurring in the transmission path.

The above-described parameter for communication having a value varying in accordance with the temperature measured at the time when the parameter is set includes, by way of example, setting of an equalizer included in the parameters 300. However, the above-described parameter for communication is not limited to setting of an equalizer but may be any of various types of communication parameters having values varying in accordance with temperature measured at the time when the communication parameters are set.

(Process Executed by CPU of Card of Running System According to First Embodiment)

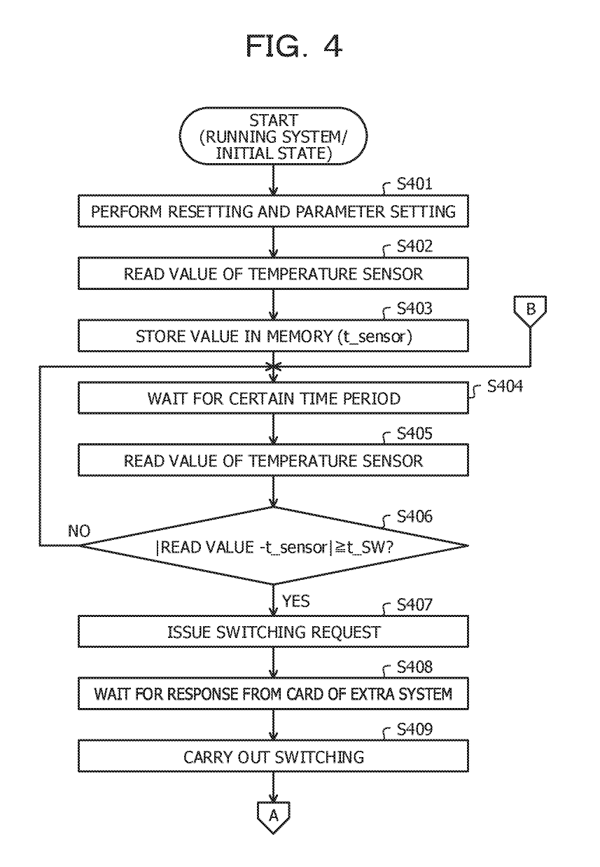

FIG. 4 is a flowchart illustrating an example of a process executed by a CPU of a card of a running system according to the first embodiment. The CPUs 111 and 121 of the first card 110 and the second card 120 execute, for example, a process illustrated in FIG. 4 by executing the software 112a and 122a when the first card 110 is set as the running system and when the second card 120 is set as the running system, respectively.

For example, each of the CPUs 111 and 121 executes the process from S401 illustrated in FIG. 4 when its card in the initial state at the time of start-up or the like is set as the running system (the running system/the initial state). Each of the CPUs 111 and 121 executes the process from S404 illustrated in FIG. 4 when its card is switched from the extra system to the running system (B). The process executed by the CPU 111 when the first card 110 is the running system will be described here, and the description applies to the process executed by the CPU 121 when the second card 120 is the running system.

First, the CPU 111 performs resetting and setting of parameters (resetting and parameter setting) of the communication LSI 114 via the internal bus 119 (S401). The parameters set for the communication LSI 114 in S401 include, by way of example, the initial value of a tap coefficient for the equalizer of the communication LSI 114. Setting of a parameter is performed, for example, when, under an instruction from the CPU 111, the communication LSI 114 determines a value to which the parameter is to be set and the communication LSI 114 stores the determined value in the register 114a of the communication LSI 114.

Next, the CPU 111 reads the value of the temperature sensor 113 via the internal bus 119 (S402). Next, the CPU 111 stores the value read in S402, as the temperature sensor read value 212 (t_sensor), via the internal bus 119 in the memory 112 (S403). This makes it possible to store the temperature sensor read value 212 representing the temperature of the communication LSI 114 measured at the time when the parameter for the communication LSI 114 is set, in the memory 112.

Next, the CPU 111 waits for a certain time period (S404). Next, the CPU 111 reads the value of the temperature sensor 113 via the internal bus 119 (S405).

Next, the CPU 111 determines whether or not the difference (absolute value) between the value read in S405 and the t_sensor is larger than or equal to t_SW (S406). That is, the CPU 111 determines whether or not the value read in S405 is larger than or equal to t_sensor+t_SW or smaller than or equal to t_sensor−t_SW. The term t_sensor is the temperature sensor read value 212 stored in the memory 112 in S403. The term t_SW is the switching threshold 214 stored in the memory 112.

If, in S406, the difference between the read value and t_sensor is not larger than t_SW (No in S406), the CPU 111 returns to S404. If the difference between the read value and t_sensor is larger than or equal to t_SW (Yes in S406), the CPU 111 issues a switching request via the communication interface 101 to the card of the extra system (the second card 120) (S407).

Next, the CPU 111 waits for a response from the card of the extra system (the second card 120) to the switching request issued in S407 (S408). The response from the card of the extra system to the switching request is given, for example, via the communication interface 101.

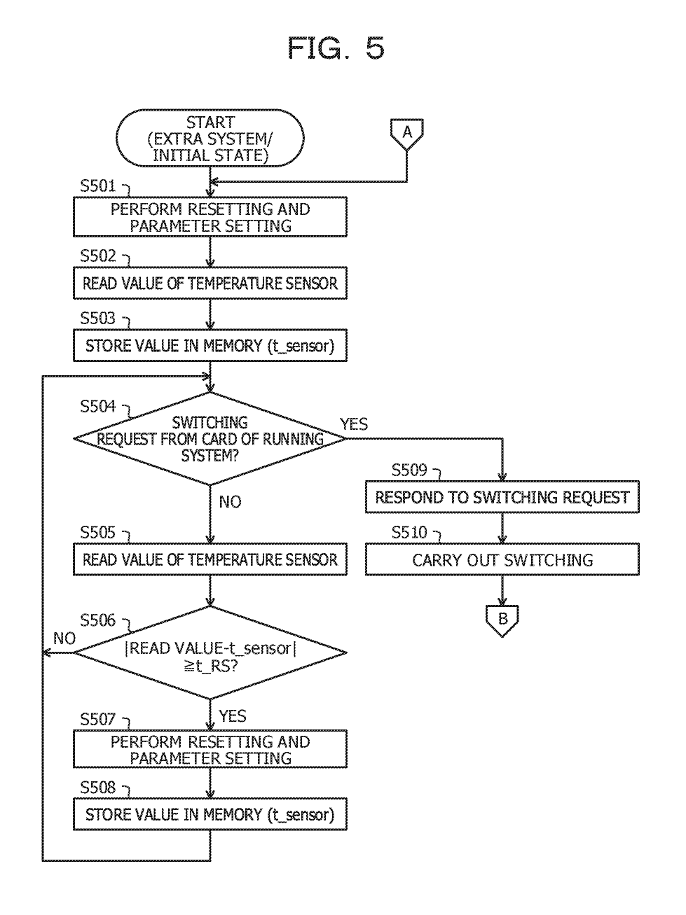

Next, the CPU 111 carries out switching to the extra system (S409) and proceeds to S501 in the process of the extra system illustrated in FIG. 5 (A). In S409, the CPU 111 overwrites the system state information 211 in the memory 112 from the “running system” to the “extra system”, for example, via the internal bus 119.

As illustrated in FIG. 4, the first card 110 of the running system stores the temperature (t_sensor) of the communication LSI 114 measured at the time when the initial setting of the communication LSI 114 is performed, in the memory 112. Further, the first card 110 regularly acquires the temperature sensor read value 212 from the temperature sensor 113, and performs switching between the running system and the extra system when the difference between the temperature sensor read value 212 and the stored temperature (t_sensor) equals or exceeds t_SW.

Additionally, at the time of switching between the running system and the extra system, the first card 110 issues a switching request to the second card 120, and waits for a response from the second card 120 before performing switching between the running system and the extra system. This avoids overlap between a timing of switching from the running system to the extra system in the first card 110 and a timing of resetting and parameter setting in the second card 120, enabling switching between the running system and the extra system to be performed with more reliability.

At this point, the margin between t_SW and t_RS (t_SW−t_RS), for example, may be set to be sufficiently large. This enables a sufficiently long time period to be ensured from a timing at which the second card 120 performs resetting and parameter setting to a time at which the first card 110 performs switching.

This enables resetting and parameter setting to be complete in the second card 120 when conditions for switching based on t_SW are satisfied in the first card 110. As a result, it is possible to avoid the case where, when conditions for switching based on t_SW are satisfied in the first card 110, switching between the running system and the extra system is not able to be performed and thus communication becomes impossible.

In this way, the CPU 111 (the switching unit) of the running system may refrain from performing switching between the running system and the extra system when the CPU 121 (the setting unit) is setting the value of a parameter for the second card 120. This makes it possible to avoid a collision between a timing at which switching between the running system and the extra system is performed and a timing at which a parameter of the extra system is set.

Additionally, the first card 110 waits for a response from the second card 120 to a switching request before performing switching, making it possible to refrain from performing switching from the running system to the extra system when the second card 120 is in a failure state or in a removed state, or not started or the like. Additionally, the first card 110 may systematically output an alarm when no response from the second card 120 to a switching request is given after passage of a given time period.

(Process Executed by CPU of Card of Extra System According to First Embodiment)

FIG. 5 is a flowchart illustrating an example of a process executed by a CPU of a card of an extra system according to the first embodiment. The CPUs 111 and 121 of the first card 110 and the second card 120 execute, for example, the process illustrated in FIG. 5 by executing the software 112a and 122a when the first card is set as the extra system and when the second card 120 is set as the extra system, respectively.

For example, each of the CPUs 111 and 121 executes the process from S501 illustrated in FIG. 5 when its card is set as the extra system in the initial state at the time of starting or the like (the extra system in its initial state) or when its card is switched from the running system to the extra system (A). The process executed by the CPU 121 when the second card 120 is the extra system will be described here, and the description applies to the process executed by the CPU 111 when the first card 110 is the extra system.

First, the CPU 121 performs resetting and parameter setting of the communication LSI 124 via the internal bus 129 (S501). The parameter set for the communication LSI 124 in S501 is, by way of example, the initial value of a tap coefficient for the equalizer of the communication LSI 124.

Next, the CPU 121 reads the value of the temperature sensor 123 via the internal bus 129 (S502). Next, the CPU 121 stores the value read in S502, as the temperature sensor read value 222 (t_sensor), via the internal bus 129 in the memory 122 (S503). This makes it possible to store the temperature sensor read value 222, which represents the temperature of the communication LSI 124 measured at the time when the parameter of the communication LSI 124 is set, in the memory 122.

Next, the CPU 121 determines whether or not a switching request is given via the communication interface 101 from the card of the running system (the first card 110) (S504). For example, the CPU 121 waits for a given time period in S504 and determines whether or not a switching request is given from the first card 110 until the time out of the given time period. If no switching request is given (No in S504), the CPU 121 reads the value of the temperature sensor 123 via the internal bus 129 (S505).

Next, the CPU 121 determines whether or not the difference (absolute value) between the read value in S505 and t_sensor is larger than or equal to t_RS (S506). That is, the CPU 121 determines whether or not the read value in S505 is larger than or equal to t_sensor+t_RS or smaller than or equal to t_sensor−t_RS. The term t_sensor is the temperature sensor read value 222 stored in the memory 122 in S503. The term t_RS is the switching threshold 224 stored in the memory 122.

If, in S506, the difference between the read value and t_sensor is not larger than or equal to t_RS (No in S506), the CPU 121 returns to S504. If the difference between the read value and t_sensor is larger than or equal to t_RS (Yes in S506), the CPU 121 performs resetting and parameter setting of the communication LSI 124 via the internal bus 129 (S507). The parameter set for the communication LSI 124 in S507 is, by way of example, the initial value of a tap coefficient for the equalizer of the communication LSI 124.

Further, the CPU 121 stores the value read in S505, as the temperature sensor read value 222 (t_sensor), in the memory 122 via the internal bus 129 (S508), and returns to S504. Note that the order of S507 and S508 may be rearranged. Additionally, S507 and S508 may be simultaneously performed.

If, in S504, a switching request is given (Yes in S504), the CPU 121 issues a response to the switching request to the card of the running system (the first card 110) via the communication interface 101 (S509). Next, the CPU 121 carries out switching to the running system (S510) and proceeds to S404 in the process of the running system illustrated in FIG. 4 (B). In S510, the CPU 121 overwrites the system state information 221 of the memory 122 from the “extra system” to the “running system”, for example, via the internal bus 129.

As illustrated in FIG. 5, the second card 120 of the extra system stores the temperature (t_sensor) measured at the time when the initial setting of the communication LSI 124 is performed, in the memory 122. The second card 120 also regularly acquires the temperature sensor read value 222 from the temperature sensor 123. Further, when the difference between the temperature sensor read value 222 and the stored temperature (t_sensor) equals or exceeds t_RS, the second card 120 performs resetting and parameter setting of the communication LSI 124 and updates the temperature sensor read value 222.

(Operating Timing of Each Card and Change in Memory Information of Each Card Relative to Temperature Change in First Embodiment)

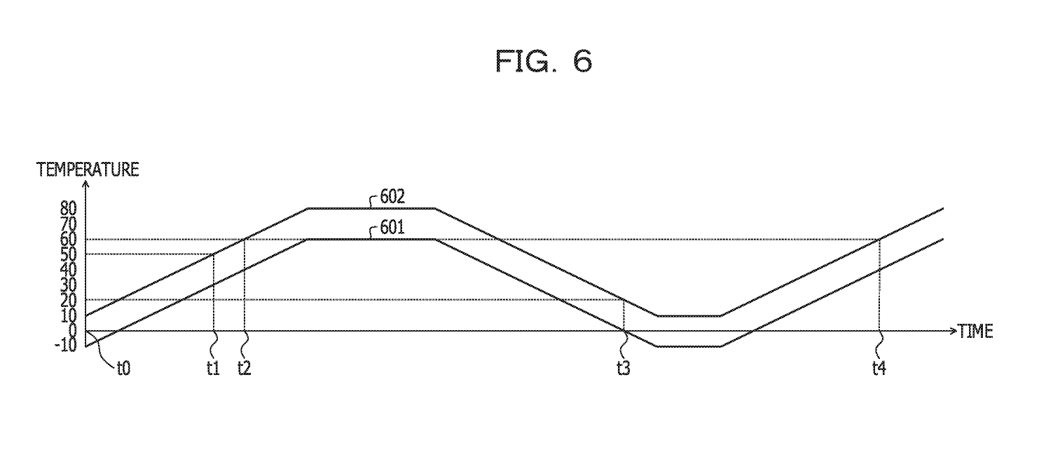

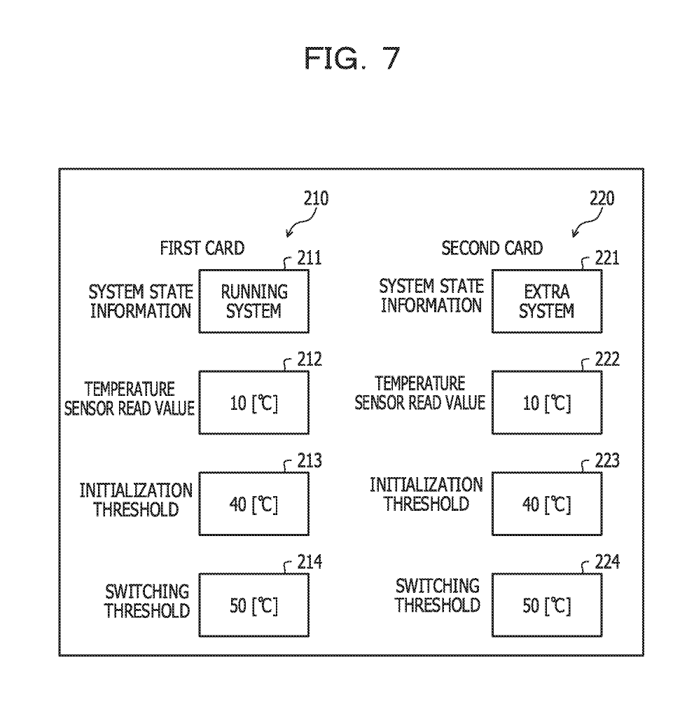

FIG. 6 is a diagram depicting an example of operating timings of each card relative to temperature change in the first embodiment. FIG. 7 to FIG. 10 are diagrams illustrating an example of changes in memory information of each card relative to temperature change in the first embodiment. In FIG. 7 to FIG. 10, portions similar to the portions illustrated in FIG. 2 are denoted by the same reference numerals and the description thereof is omitted.

In FIG. 6, the horizontal axis represents the passage of time and the vertical axis represents the temperature of the communication LSI 114 or 124. Environmental temperature 601 is the temperature of the environment in which the communication apparatus 100 is placed. The temperatures of the cases of the communication LSIs 111 and 124 are assumed to be approximately the same in the example depicted in FIG. 6. A case temperature 602 is the temperature of the case of each of the communication LSIs 114 and 124. The case temperature 602 after power on is 20° C. higher than the environmental temperature 601 at any time.

In the initial state, as illustrated in FIG. 7, in the memories 112 and 122 of the first card 110 and the second card 120, it is assumed that information representing 40° C. is stored as each of the initialization thresholds 213 and 223 (t_SW). It is also assumed that information representing 50° C. is stored as each of the switching thresholds 214 and 224 in the memories 112 and 122.

In the initial state, the first card 110 is set as the running system and the second card 120 is set as the extra system. That is, as illustrated in FIG. 7, the “running system” is stored as the system state information 211 in the memory 112 of the first card 110. Additionally, the “extra system” is stored as the system state information 221 in the memory 122 of the second card 120.

Additionally, the temperature range over which the communication apparatus 100 is guaranteed to operate is assumed to be from −10° C. to 60° C., and the temperature range over which the communication LSIs 114 and 124 are guaranteed to operate is assumed to include a range from −10° C. to 60° C. Additionally, it is assumed that the parameter set at a certain temperature T0 is effective for a temperature range of T0±50° C., and exceeding this temperature range will result in a communication error or the like. Accordingly, as mentioned above, 50° C. is set as each of the switching thresholds 214 and 224. Additionally, as mentioned above, 40° C., which is lower than 50° C., is set as each of the initialization thresholds 213 and 223. Note that an example of the error is a state in which, when the communication LSI 114 transmits a signal, for example, modulation or the like is not normally performed. Another example of the error is a state in which, when the communication LSI 114 receives a signal, for example, demodulation or the like is not normally performed.

The time t0 on the horizontal axis is, for example, a time at which the first card 110 and the second card 120 are powered on. The first card 110, which is set, in its initial state, as the running system, starts to perform the process of the running system illustrated in FIG. 4 from the time t0. The second card 120, which is set, in its initial state, as the extra system, starts to perform the process of the extra system illustrated in FIG. 5 from the time t0.

Additionally, at the time t0, the environmental temperature 601 is assumed to be −10° C., and the case temperature 602 is assumed to be 10° C. Accordingly, in the first card 110 and the second card 120, through resetting and parameter setting for the communication LSIs 114 and 124, suitable parameters in accordance with the case temperature 602 of 10° C. are set for the communication LSIs 114 and 124, respectively.

At this point, as illustrated in FIG. 7, in the memories 112 and 122 of the first card 110 and the second card 120, 10° C. is set as each of the temperature sensor read values 212 and 222. Accordingly, the parameters set for the communication LSIs 114 and 124 are effective in the range of case temperatures from −40° C. to 60° C. (10±50° C.).

Next, it is assumed that, from the time t0, the case temperature 602 rises as the environmental temperature 601 rises, and the case temperatures 602 equals 50° C. at a time t1. In this case, in the second card 120 serving as the extra system, the difference between the temperature sensor read value 222 (10° C.) and the read value (50° C.) of the temperature sensor 123 reaches the initialization threshold 223 (40° C.). Therefore, the second card 120 performs resetting and parameter setting of the communication LSI 124 and updates the temperature sensor read value 222.

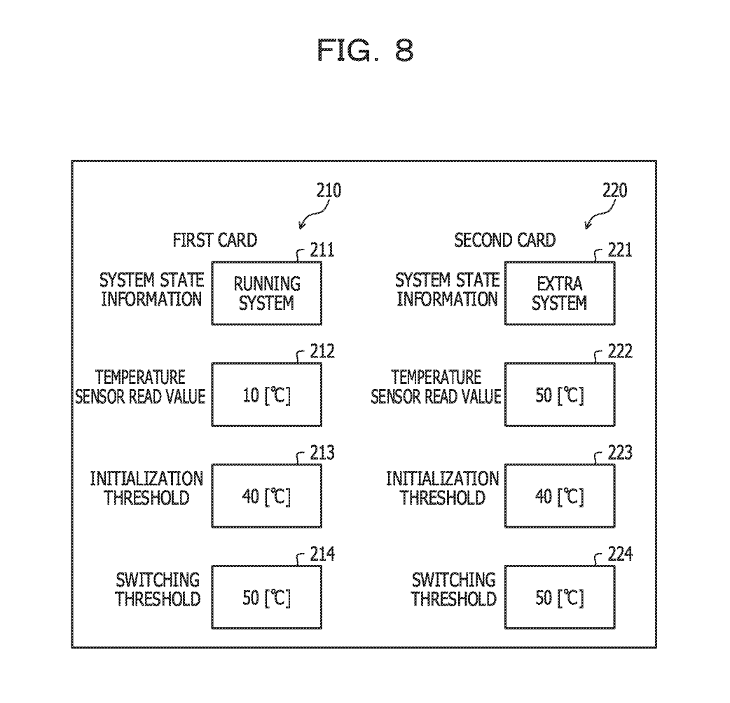

Additionally, as illustrated in FIG. 8, the second card 120 stores the read value (50° C.) of the temperature sensor 123 at this point, as a new value of the temperature sensor read value 222, in the memory 122. Additionally, in the resetting and parameter setting of the communication LSI 124, the second card 120 sets parameters in accordance with 50° C. of the case temperature 602 for the communication LSI 124. Accordingly, the parameters set for the communication LSI 124 are effective in the range of case temperatures from 0° C. to 100° C. (50±50° C.).

Next, it is assumed that, from the time t1, the case temperature 602 rises as the environmental temperature 601 rises, and the case temperature 602 equals 60° C. at a time t2. In this case, in the first card 110 serving as the running system, the difference between the temperature sensor read value 212 (10° C.) and the read value (60° C.) of the temperature sensor 113 reaches the switching threshold 214 (50° C.). Accordingly, the first card 110 performs switching between the running system and the extra system by issuing a switching request to the second card 120.

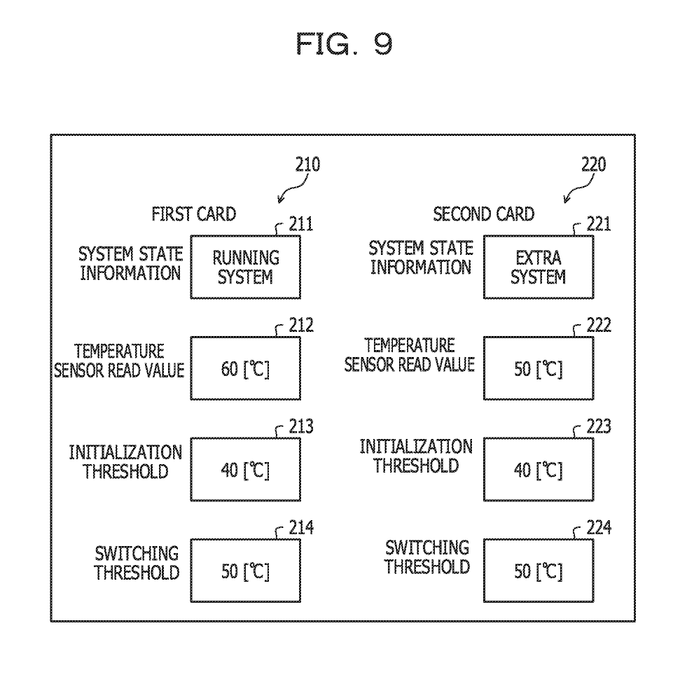

Thus, as illustrated in FIG. 9, the system state information 211 of the first card 110 changes to the “extra system” and the system state information 221 of the second card 120 changes to the “running system”. That is, the second card 120 serves as the running system, and the first card 110 serves as the extra system. Additionally, as illustrated in FIG. 9, the first card 110 stores the case temperature 602 (60° C.) at the time t2, as a new value of the temperature sensor read value 212, in the memory 112.

Additionally, the parameters set for the communication LSI 124 of the second card 120 at the time t1 are effective in the range of case temperatures from 0° C. to 100° C. (50±50° C.). Therefore, if switching to the running system is performed at the time t2, at which the case temperature 602 is 60° C., a temperature rise of 40° C. and a temperature decrease of 60° C. are allowable with respect to the temperature range of 0 to 100° C. in which the parameters are effective. This enables the card to operate as the running system with reliability.

Next, it is assumed that, from the time t2, the case temperature 602 rises as the environmental temperature 601 rises, thereafter the case temperature 602 decreases as the environmental temperature 601 decreases, and, at a time t3, the case temperature 602 equals 20° C. In this case, since the difference between the temperature sensor read value 212 (60° C.) and the read value (20° C.) of the temperature sensor 113 reaches the initialization threshold 213 (40° C.), the first card 110 serving as the extra system performs resetting and parameter setting of the communication LSI 114.

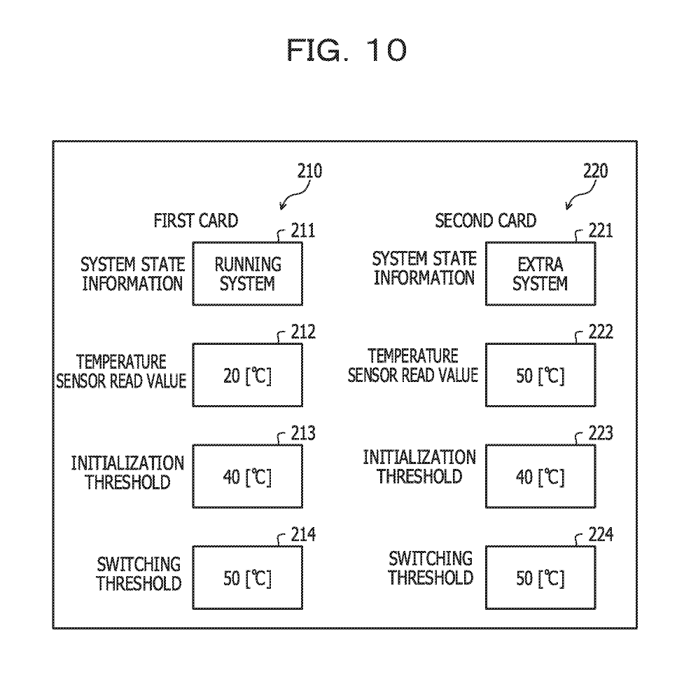

Additionally, as illustrated in FIG. 10, the first card 110 stores the read value (20° C.) of the temperature sensor 113 at this point, as a new value of the temperature sensor read value 212, in the memory 112. The first card 110 also sets suitable parameters in accordance with the case temperature 602 of 20° C. in resetting and parameter setting of the communication LSI 114. Accordingly, the parameters set for the communication LSI 114 are effective in the range of case temperatures from −30° C. to 70° C. (20±50° C.).

Next, it is assumed that, from the time t3, the case temperature 602 decreases as the environmental temperature 601 decreases, thereafter the case temperature 602 rises as the environmental temperature 601 rises, and, at a time t4, the case temperature 602 equals to 60° C. In this case, in the first card 110 serving as the extra system, the difference between the temperature sensor read value 212 (20° C.) and the read value (60° C.) of the temperature sensor 113 reaches the initialization threshold 213 (40° C.). Therefore, the first card 110 performs resetting and parameter setting of the communication LSI 114.

Additionally, the first card 110 stores the read value (60° C.) of the temperature sensor 113 at this point, as a new value of the temperature sensor read value 212, in the memory 112. Thus, each information of the memories 112 and 122 of the first card 110 and the second card 120 is in a state illustrated in FIG. 9. In resetting and parameter setting of the communication LSI 114, the first card 110 sets suitable parameters in accordance with the case temperature 602 of 60° C. Accordingly, the parameters set for the communication LSI 114 are effective in the range of case temperatures from 10° C. to 110° C. (60±50° C.).

Thereafter, it is assumed that, for example, the environmental temperature 601 is repeatedly varied in the range from −10° C. to 60° C. In this case, the first card 110 serving as the extra system performs resetting and parameter setting at the case temperature 602 of 40° C. during a temperature rise and at the case temperature 602 of 0° C. during a temperature decrease, and updates the temperature sensor read value 212. Additionally, in this case, since, in the second card 120 serving as the running system, the switching conditions are not satisfied, switching between the running system and the extra system does not occur in the first card 110 and the second card 120. Note that although the case where the environmental temperature 601 repeatedly varies in the range from −10° C. to 60° C. has been described here, the environmental temperature 601 may irregularly change during actual operations.

(Another Example of Process Executed by CPU of Card of Running System According to First Embodiment)

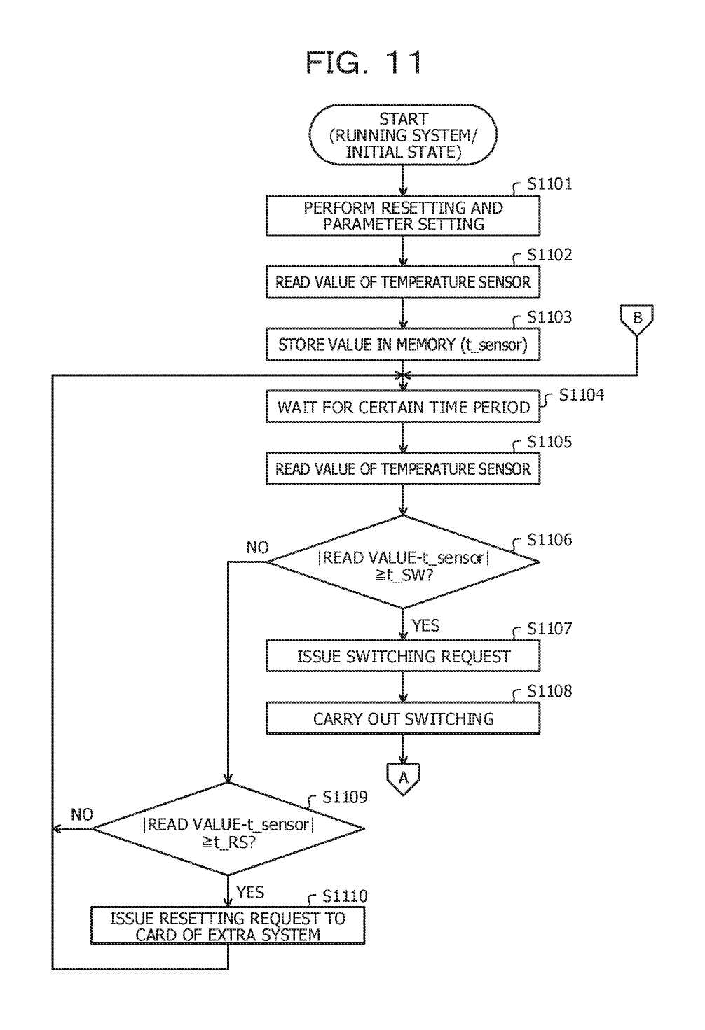

FIG. 11 is a flowchart illustrating another example of the process executed by the CPU of the running system according to the first embodiment. Each of the CPUs 111 and 121 of the first card 110 and the second card 120 may execute, for example, the process illustrated in FIG. 11 when its card is set as the running system. For the example illustrated in FIG. 11, a process executed when the card of the running system controls resetting and parameter setting of the card of the extra system will be described. The process executed by the CPU 111 when the first card 110 is the running system will be described here, and the description applies to a process executed by the CPU 121 when the second card 120 is the running system.

S1101 to S1107 illustrated in FIG. 11 are similar to S401 to S407 illustrated in FIG. 4. In the example illustrated in FIG. 11, resetting and parameter setting of the second card 120 is controlled by the CPU 111, and therefore the CPU 111 does not have to wait for a response from the card of the extra system (the second card 120) to a switching request issued in S1107.

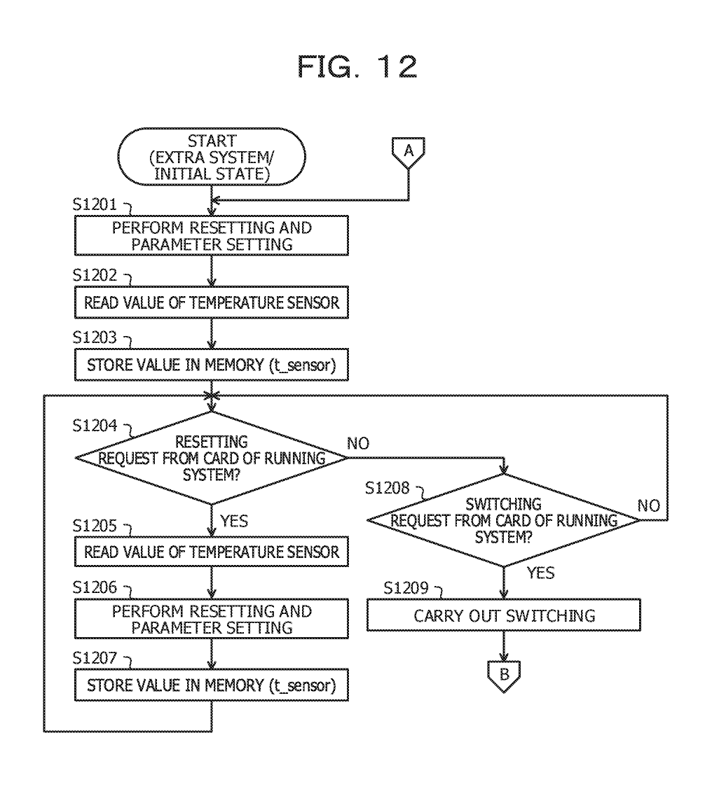

Accordingly, next to S1107, the CPU 111 carries out switching to the extra system (S1108), and proceeds to S1201 in the process of the extra system illustrated in FIG. 12 (A). In S1108, the CPU 111 overwrites the system state information 211 of the memory 112 from the “running system” to the “extra system”, for example, via the internal bus 119.

In S1106, if the difference between the read value and t_sensor is not larger than or equal to t_SW (No in S1106), the CPU 111 proceeds to S1109. That is, the CPU 111 determines whether or not the difference (absolute value) between the read value obtained in S1105 and t_sensor is larger than or equal to t_RS (S1109). This processing is similar to, for example, the processing in S506 in the extra system illustrated in FIG. 5.

If, in S1109, the difference between the read value and t_sensor is not larger than or equal to t_RS (No in S1109), the CPU 111 returns to S1104. If the difference between the read value and t_sensor is larger than or equal to t_RS (Yes in S1109), the CPU 111 issues a resetting request to the card of the extra system (the second card 120) via the communication interface 101 (S1110). Further, the CPU 111 returns to S1104.

(Another Example of Process Executed by CPU of Card of Extra System According to First Embodiment)

FIG. 12 is a flowchart illustrating another example of the process executed by the CPU of the card of the extra system according to the first embodiment. When the card of the running system out of the first card 110 and the second card 120 executes the process illustrated in FIG. 11, the card of the extra system out of the first card 110 and the second card 120 executes, for example, the process illustrated in FIG. 12. The process executed by the CPU 121 when the second card 120 is the extra system will be described here, and the description applies to the process executed by the CPU 111 when the first card 110 is the extra system.

S1201 to S1203 illustrated in FIG. 12 are similar to S501 to S503 illustrated in FIG. 5. Next to S1201 to S1203, the CPU 121 determines whether or not a resetting request is given from the card of the running system (the first card 110) via the communication interface 101 (S1204).

If, in S1204, a resetting request is given (Yes in S1204), the CPU 121 executes S1205 to S1207 and returns to S1204. S1205 to S1207 are similar to S505, S507, and S508 illustrated in FIG. 5. That is, regardless of whether or not the difference (absolute value) between the value read from the temperature sensor 123 and t_sensor is larger than or equal to t_RS, the CPU 121 performs resetting and parameter setting of the communication LSI 124 and updates the temperature sensor read value 222.

If, in S1204, no resetting request is given (No in S1204), the CPU 121 determines whether or not a switching request is given from the card of the running system (the first card 110) via the communication interface 101 (S1208). If no switching request is given (No in S1208), the CPU 121 returns to S1204.

If, in S1208, a switching request is given (Yes in S1208), the CPU 121 carries out switching to the running system (S1209), and proceeds to S1104 in the process of the running system illustrated in FIG. 11(B). In S1209, the CPU 121 overwrites the system state information 221 of the memory 122 from the “extra system” to the “running system”, for example, via the internal bus 129.

As illustrated in FIG. 11 and FIG. 12, the card of the running system controls resetting and parameter setting of the card of the extra system, thereby making it possible to avoid a collision between a timing at which switching between the running system and the extra system is performed and a timing at which resetting and parameter setting of the extra system is performed. In this case, the setting unit, which sets the value of a parameter for the second card 120 of the extra system, for example, during a period when communication with the opposing communication apparatus is performed by the first card 110 of the running system, may be implemented by the CPU 111 of the first card 110.

For example, the CPU 111 (the switching unit) of the running system may refrain from performing switching between the running system and the extra system when the CPU 111 (the setting unit) is setting the value of a parameter for the second card 120 of the extra system. This makes it possible to avoid a collision between a timing at which switching between the running system and the extra system is performed and a timing at which a parameter of the extra system is set.

In this way, according to the communication apparatus 100 according to the first embodiment, it is possible to set the value of a parameter of the second card 120 during a period when communication with the opposing communication apparatus is performed by the first card 110 of the running system. During this, setting of the value of a parameter of the first card 110 is not performed, and therefore communication performed by the first card 110 may continue. Thus, during a period when communication with the opposing communication apparatus is performed by the first card 110 of the running system, the values of parameters of the second card 120 may be maintained to values suitable for the environmental temperature.

Accordingly, when the environmental temperature greatly changes, for example, it is possible to avoid errors occurring similarly in the first card 110 and the second card 120. Therefore, when the temperature of the first card 110 greatly changes from that at the time at which the parameters of the first card 110 are set, the communication circuit that performs communication with the opposing communication apparatus is enabled to be switched with reliability from the first card 110 to the second card 120.

Additionally, the value of a parameter of the second card 120 during a period when communication is performed by the first card 110 of the running system may be set when the difference between the temperature at the time of setting the value of the parameter and the current temperature equals or exceeds a first given value in the second card 120. The first given value is a value smaller than a second given value used as a reference for switching between the running system and the extra system. Thus, when the environmental temperature greatly changes, it is possible to set the values of parameters of the second card 120 before switching between the running system and the extra system occurs. Therefore, when the temperature of the first card 110 greatly changes from that at the time at which the parameters of the first card 110 are set, the communication circuit that performs communication with the opposing communication apparatus is enabled to be switched from the first card 110 to the second card 120 with more reliability.

Note that, although the configuration in which the first card 110 and the second card 120 are provided with the temperature sensors 113 and 123, respectively, has been described in the first embodiment, the present disclosure is not limited to such a configuration. For example, the communication apparatus 100 may be provided with one temperature sensor, by which the temperature inside the communication apparatus 100 is measured, so that the temperatures of the communication LSIs 114 and 124 are indirectly measured.

In addition, although the configuration in which the communication apparatus 100 includes the first card 110 and the second card 120 has been described, the present disclosure is not limited to such a configuration. For example, the first card 110 may be provided with a plurality of communication LSIs such that the plurality of communication LSIs are used as the running system and the extra system. In this case, the CPU 111 performs control over the plurality of communication LSIs, and the memory 112 stores each information about the plurality of communication LSIs. In this case, a configuration in which the second card 120 is removed may be employed. Additionally, in this case, a configuration corresponding to the first card 110 does not have to be of a card type.

### Second Embodiment

For a second embodiment, portions different from those in the first embodiment will be described. Although, in the first embodiment, the case where, when the difference (absolute value) between the value read from the temperature sensor 113 or 123 and t_sensor is larger than or equal to t_RS, resetting and parameter setting of the extra system is performed has been described, the present disclosure is not limited to such a configuration. In the second embodiment, the case where resetting and parameter setting of the extra system is regularly performed will be described.

(Process Executed by CPU of Card of Extra System According to Second Embodiment)

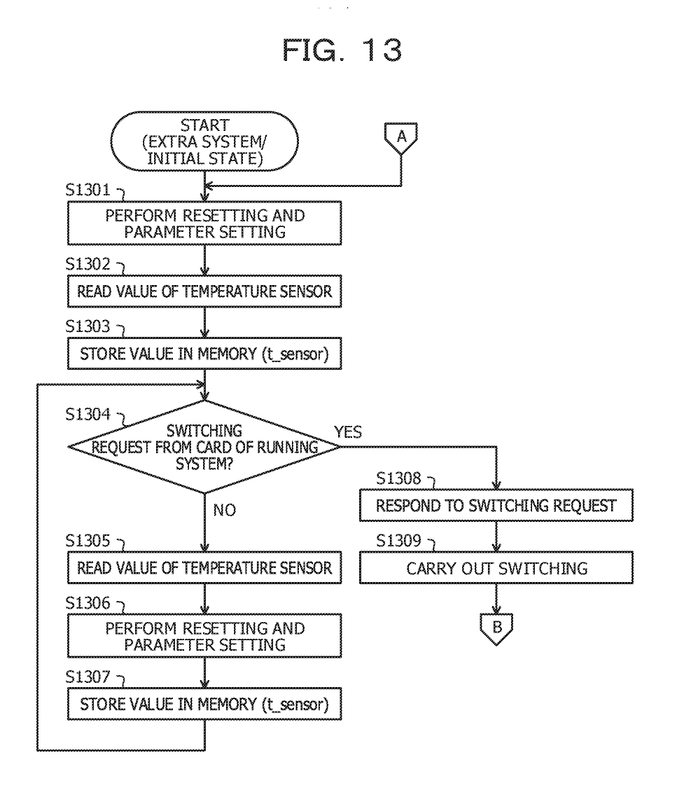

FIG. 13 is a flowchart illustrating an example of a process executed by the CPU of the card of the extra system according to the second embodiment. The CPUs 111 and 121 of the first card 110 and the second card 120 according to the second embodiment execute, for example, the process illustrated in FIG. 13 by executing the software 112a and 122a when the first card 110 is set as the extra system and when the second card 120 is set as the extra system, respectively.

In the example illustrated in FIG. 13, the process of the card of the running system is similar to, for example, the process illustrated in FIG. 4. The process executed by the CPU 121 when the second card 120 is the extra system will be described here, and the description applies to the process executed by the CPU 111 when the first card 110 is the extra system.

S1301 to S1305 illustrated in FIG. 13 are similar to S501 to S505 illustrated in FIG. 5. Upon reading the value of the temperature sensor 123 in S1305, the CPU 121 performs resetting and parameter setting of the communication LSI 124 (S1306). The CPU 121 also stores the value read in S1305, as the temperature sensor read value 222 (t_sensor), in the memory 122 (S1307), and returns to S1304.

That is, regardless of whether the difference between the value read from the temperature sensor 123 and t_sensor is larger than or equal to t_RS, the CPU 121 regularly performs resetting and parameter setting of the communication LSI 124 and updating the temperature sensor read value 222. Note that the order of S1306 and S1307 may be rearranged. Additionally, S1306 and S1307 may be simultaneously performed.

S1308 and S1309 illustrated in FIG. 13 are similar to S509 and S510 illustrated in FIG. 5.

(Operating Timing of Each Card Relative to Temperature Change in Second Embodiment)

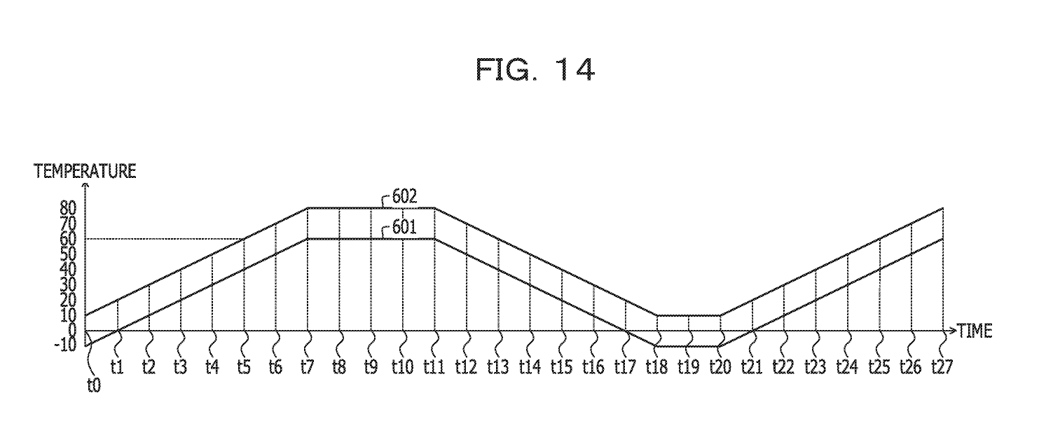

FIG. 14 is a diagram depicting an example of operating timings of each card relative to temperature change in the second embodiment. In FIG. 14, portions similar to the portions depicted in FIG. 6 are denoted by the same reference numerals and the description thereof is omitted. In the second embodiment, the second card 120 set as the extra system in the initial state performs resetting and parameter setting of the LSI 124 and updating of the temperature sensor read value 222 at times t0, t1, t2, t3, . . . , which are spaced at regular intervals.

In addition, it is assumed that, from the time t0, the case temperature rises as the environmental temperature 601 rises, and, at the time t5, the case temperature 602 equals 60° C. In this case, since the difference between the temperature sensor read value 212 (10° C.) and the read value (60° C.) of the temperature sensor 113 reaches the switching threshold 214 (50° C.), the first card 110 serving as the running system performs switching between the running system and the extra system.

(Another Example of Process Executed by CPU of Card of Running System According to Second Embodiment)

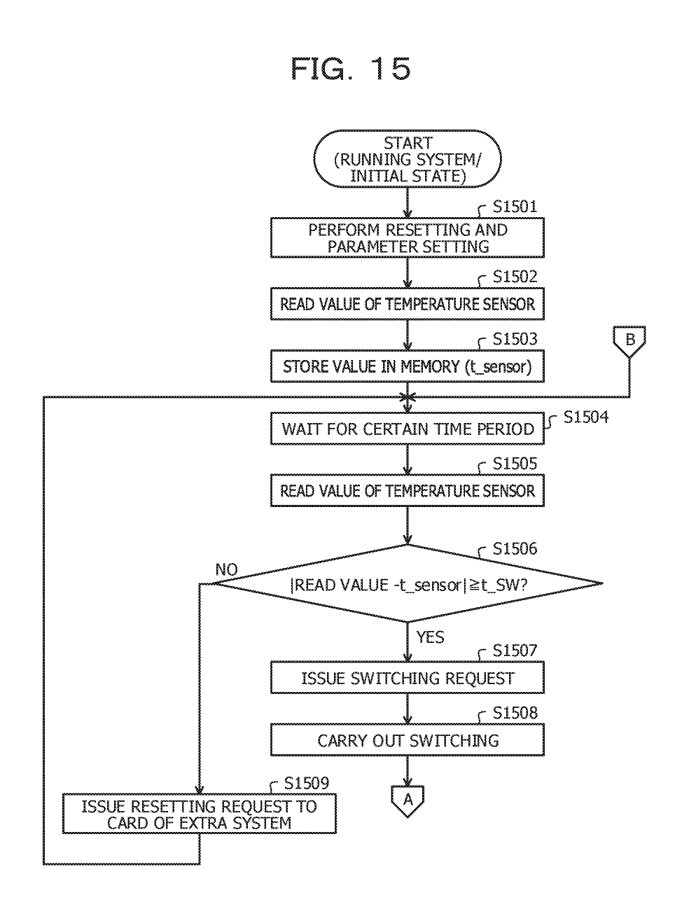

FIG. 15 is a flowchart illustrating another example of the process executed by the CPU of the card of the running system according to the second embodiment. Each of the CPUs 111 and 121 of the first card 110 and the second card 120 according to the second embodiment may execute, for example, the process illustrated in FIG. 15, when its card is set as the running system. In the example illustrated in FIG. 15, the process of the case where the card of the running system controls resetting and parameter setting of the card of the extra system will be described.

In the example illustrated in FIG. 15, the process for the card of the extra system is similar, for example, to the process illustrated in FIG. 12. The process executed by the CPU 111 when the first card 110 is the running system will be described here, and the description applies to the process executed by the CPU 121 when the second card 120 is the running system.

S1501 to S1507 illustrated in FIG. 15 are similar to S401 to S407 illustrated in FIG. 4. In the example illustrated in FIG. 15, resetting and parameter setting of the second card 120 is controlled by the CPU 111, and therefore the CPU 111 does not have to wait for a response from the card of the extra system (the second card 120) to a switching request issued in S1507.

Next to S1507, the CPU 111 carries out switching to the extra system (S1508), and proceeds to S1201 in the process of the extra system illustrated in FIG. 12 (A). In S1508, the CPU 111 overwrites the system state information 211 of the memory 112 from the “running system” to the “extra system”, for example, via the internal bus 119.

In S1506, if the difference between the read value and t_sensor is not larger than or equal to t_SW (No in S1506), the CPU 111 proceeds to S1509. That is, the CPU 111 issues a resetting request to the card of the extra system (the second card 120) via the communication interface 101 (S1509), and returns to S1504.

As illustrated in FIG. 12 and FIG. 15, the card of the running system controls resetting and parameter setting of the card of the extra system, thereby making it possible to avoid a collision between a timing at which switching between the running system and the extra system is performed and a timing at which resetting and parameter setting of the extra system is performed. In this case, the setting unit, which sets the value of a parameter of the second card 120 of the extra system, for example, during a period when communication with the opposing communication apparatus is performed by the first card 110 of the running system, may be implemented by the CPU 111 of the first card 110.

For example, the CPU 111 (the switching unit) of the running system may refrain from performing switching between the running system and the extra system when the CPU 111 (the setting unit) is setting the value of a parameter for the second card 120 of the extra system. This makes it possible to avoid a collision between a timing at which switching between the running system and the extra system is performed and a timing at which a parameter of the extra system is set.

In this way, according to the second embodiment, as in the first embodiment, when the temperature of the first card 110 greatly changes from that at the time at which parameters of the first card 110 are set, a communication circuit that performs communication is enabled to be switched from the first card 110 to the second card 120 with reliability. Additionally, with the communication apparatus 100 according to the second embodiment, setting of the values of parameters of the second card 120 of the extra system may be regularly performed during a period when communication is performed by the first card 110 of the running system.

Note that the embodiments described above are merely illustrative and are in no way intended to exclude various modifications and technical applications that are not explicitly described hereinbefore.

As described above, according to the communication apparatus and the switching method, switching between the running system and the extra system is enabled to be performed with reliability when temperature changes.

For example, some of the recent LSIs are strict in terms of temperature characteristics or the like and operate in different modes depending on the environmental temperature at the time of start-up. For example, once the environmental temperature changes from the temperature at the time of start-up of an LSI, the LSI is sometimes impossible to operate optimally. Among such LSIs, an LSI used in a transmission system performs, for example, control of an equalizer that changes frequency characteristics of a received signal.

An equalizer is a circuit for allowing a signal having a waveform degraded in the transmission path to be received such that the waveform is recovered from its degraded state, and operates so as to maintain a state where a signal is optimally received while applying fine adjustments to the set value within the equalizer. However, in some of the cases where the environmental temperature greatly changes, adjustments within the equalizer are not able to follow the change, resetting and reconfiguration of parameters have to be performed in order to restore the state where a signal is optimally received.

In contrast, according to the embodiments described above, cards each including a component whose operating mode varies depending on the environmental temperature are arranged in a redundant configuration, a temperature sensor that measures the temperature of a target component is included, and the set value of a component of the extra-system card may be changed to follow a change in the environmental temperature. Thus, it is enabled that, if the environmental temperature changes, redundancy switching inhibits the service from being affected by the change. Accordingly, in a transmission system, when a change in the environmental temperature results in the necessity for resetting and reconfiguration of parameters in a communication LSI, redundant switching enables the service to continue without influence on communication.

Additionally, for example, in a rack-mount transmission device that offers various types of communication services, cards for main signals are operated in a redundant system. Typically, the initial setting of each of communication LSIs mounted on these cards, both in the running system and in the extra system, is carried out only once at the time when the communication LSI is started by power on or resetting. That is, there is no change to the setting after the communication LSI has entered the running state. This is because, if the communication LSI that has entered the running state is reset or reconfigured, information being communicated at this time will be lost.

In a rack-mount transmission device, cards in the redundant configuration are arranged adjacent to each other in a shelf, and therefore the environmental temperatures of both the cards are approximately the same. In such a running form, when communication LSIs having strict temperature characteristics are mounted, there are some cases where a change in the environmental temperature causes communication errors to occur similarly in the running system and in the extra system. Further, when the times at which errors occur are approximately the same, redundant switching is not able to be performed, leading to interruption of the service.

Additionally, when the running system and the extra system vary in terms of temperature characteristics, and no error has occurred in the extra system while an error has occurred in the running system, redundant switching allows the service to continue. However, if the temperature change continues, both the systems are in similar operating modes, and therefore, in a short time, a communication error occurs in the running system operating after the switching.

At this event, if resetting of a card that newly serves as the extra system is performed so that the card is reconfigured, the card enters a mode in which the card stably operates at a temperature close to the set temperature. Therefore, the service is restored by redundant switching. However, at this point, if redundant switching is not able to be performed because the extra system is being restarted, a time period over which the service is interrupted extends until reconfiguration of the extra system is complete.

In contrast, according to the embodiments described above, for a communication LSI that has to be reset and reconfigured in order to be recovered from its error state caused by a temperature change, resetting and reconfiguration may be performed only when the communication LSI is mounted on the extra-system card in a redundant configuration. That is, resetting and reconfiguration of a communication LSI mounted on the running-system card is not performed. Additionally, redundant switching between the running system and the extra system may be performed before a temperature change causes a communication error to occur to affect the service. Thus, for example, in transmission systems such as SONET or SDH and Ethernet, it is possible to inhibit communication errors and service interruptions caused by temperature change.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication apparatus configured to communicate with an external and to set a parameter for ensuring predetermined communication quality of received signal comprising:
a first communication circuit configured to set a first parameter in accordance with a first temperature thereof while the first communication circuit communicates with the external; and
a second communication circuit configured to set a second parameter in accordance with a second temperature thereof while the first communication circuit communicates with the external,
wherein when a difference between the first temperature and a temperature of the first communication circuit after setting the first parameter equals or exceeds a predetermined value, communicating with the external switches from the first communication circuit to the second communication circuit.

2. The communication apparatus according to claim 1, wherein when one of the first and second communication circuit communicates with the external, another communication circuit stops communicating with the external.

3. The communication apparatus according to claim 1, wherein each of the first and the second communication circuit sets the first and the second parameter in response to booting, respectively, and
the second parameter is reset by rebooting the second communication circuit while the first communication circuit communicates with the external.

4. The communication apparatus according to claim 1, further comprising a storage configured to store the first temperature,
wherein when a difference between the stored first temperature and a temperature of the first communication circuit after setting the first parameter equals or exceeds the predetermined value, the communication circuit communicating with the external switches from the first communication circuit to the second communication circuit.

5. The communication apparatus according to claim 1, wherein when the communication circuit communicating with the external switches to the first communication circuit, the second communication circuit resets the first parameter while the second communication circuit communicates with the external, and
the communication circuit communicating with the external switches from the second communication circuit to the first communication circuit when a difference between the second temperature and a temperature of the second communication circuit after the setting of the second parameter equals or exceeds the predetermined value.

6. The communication apparatus according to claim 1, wherein when the second communication circuit sets the second parameter therein, switching of the communication circuit that communicates with the external is disenable.

7. The communication apparatus according to claim 1, wherein when the first communication circuit communicates with the external and a difference between the second temperature and a temperature of the second communication circuit after setting the second parameter equals or exceeds a first predetermined value, the second communication circuit resets the parameter therein, and
when a difference between the first temperature and a temperature after setting the first parameter therein equals or exceeds a second predetermined value greater than the first predetermined value, the communication circuit communicating with the external switches from the first communication circuit to the second communication circuit.

8. The communication apparatus according to claim 1, wherein the second communication circuit regularly resets the parameter therein while the first communication circuit communicates with the external.

9. A communication method configured to communicate with an external for ensuring predetermined communication quality of received signal, comprising:
setting a first parameter in accordance with a first temperature of a first communication circuit while the first communication circuit communicates with the external;
setting a second parameter in accordance with a second temperature of a second communication circuit while the first communication circuit communicates with the external; and
switching a communication circuit communicating with the external from the first communication circuit to the second communication circuit when a difference between the first temperature and a temperature of the first communication circuit after setting the first parameter equals or exceeds a predetermined value.

10. The communication method according to claim 9, wherein when one of the first and second communication circuit communicates with the external, another communication circuit stops communicating with the external.

11. The communication method according to claim 9, wherein each of the first and the second communication circuit sets the first and the second parameter in response to booting, respectively, and
the second parameter is reset by rebooting the second communication circuit while the first communication circuit communicates with the external.

12. The communication method according to claim 9, further comprising storing a first temperature of the first communication circuit upon setting of the parameter,
wherein when a difference between the first temperature and a temperature of the first communication circuit after setting the first parameter equals or exceeds the predetermined value, the communication circuit communicating with the external switches from the first communication circuit to the second communication circuit.
